(19) United States
(12) Patent Application Publication
(10) Pub. No.: US 2011/0169455 A1
(43) Pub. Date: Jul. 14, 2011

(54) MULTIPLE SERIES/MULTIPLE PARALLEL BATTERY PACK

(75) Inventor: Kazuhisa Nagase, Kanagawa (JP)

(73) Assignee: NEC ENERGY DEVICES, LTD., Kanagawa (JP)

(21) Appl. No.: 13/119,996

(22) PCT Filed: Sep. 16, 2009
(86) PCT No.: PCT/JP2009/004629

§ 371 Date: Mar. 21, 2011

(30) Foreign Application Priority Data
Sep. 25, 2008 (JP) 2008-245065

(51) Int. Cl. H02J 7/04

(52) U.S. Cl. 320/118; 320/126

(57) ABSTRACT

Provided is a multiple series/multiple parallel battery pack which is capable of operating at a proper timing, and which, even if lead wires for voltage measurement extending from secondary batteries are short-circuited, gives no damage to the secondary batteries or lead wires. Thus, the multiple series/multiple parallel battery pack according to the present invention comprises a plurality of units which are connected in series and a control circuit for performing control by means of a charge stop signal and a discharge stop signal output from each of the units. Each of the units is provided with a plurality of secondary batteries 10-1 to 10-8 which are connected in series, a voltage detection circuit 15 having a function of detecting the voltages of the individual secondary batteries and a function of outputting a charge stop signal 13 and a discharge stop signal 14 according to the result of the detection of the voltage, and lead wires 11 for transmitting the voltages of the secondary batteries to the control circuit or an external circuit. A resistor is inserted in series into a mid portion 12 of each of the lead wires, or a differential amplifier is connected to the mid portion 12 so as to transmit the output thereof to the outside.

### TECHNICAL FIELD

The present invention relates to a secondary battery pack that supplies power to an electronic device, etc. and, more particularly, to a multiple series/multiple parallel battery pack having batteries in multiple series/parallel configuration.

### BACKGROUND ART

When used as a power supply for an electric device, a secondary battery such as a lithium-ion battery is generally configured as a secondary battery pack formed integrally with a protection circuit that detects the voltage or current of a secondary battery and opens/closes a power supply line so as to perform charging/discharging control. In recent years, development of a high voltage/large capacity secondary battery pack has proceeded in response to users' request. In order to comply with such a request, a large number of secondary batteries are combined in series and in parallel so as to achieve a high voltage/large capacity power supply.

FIG. 4 is a circuit diagram illustrating an example of a configuration of such a conventional secondary battery pack. In FIG. 4, with a plurality of secondary batteries connected in series treated as one unit, the secondary battery pack has four units 20-1, 20-2, 20-3, and 20-4 which are connected in series, a switch element 22 for opening/closing a power supply line, and a control circuit 23 that controls the switch element 22 based on information of the secondary batteries so as to control charging/discharging operation.

FIG. 5 is a circuit diagram illustrating an example of a configuration of one unit of the conventional secondary battery pack. In FIG. 5, eight secondary batteries 30-1 to 30-8 are connected in series to constitute one unit. In this case, in order for control to be performed by the control circuit 23, the voltage of each secondary battery is transmitted to the control circuit 23 via a lead wire 31 for voltage measurement extending from each secondary battery. The control circuit 23 makes a determination based on the measured voltage and performs protective operation such as control of the switch element 22. An example of a wiring technique of the lead wire is disclosed in Patent Document 1.
Patent Document 1: JP-A-2001-6644

### DISCLOSURE OF THE INVENTION

### Problems to be Solved by the Invention

In the conventional secondary battery pack illustrated in FIGS. 4 and 5, when the number of the units is increased for obtaining a power supply with higher voltage/larger capacity to increase the number of secondary batteries used in the secondary battery pack, a situation occurs in which the control circuit 23 for performing the protective operation needs to monitor the voltages of all the large number of secondary batteries, thus taking much time for control processing of the control circuit 23, which may prevent detection of overcharge or overdischarge and prevent corresponding protective processing to be carried out at a proper timing.

Further, in the case where the lead wires 31 which are directly connected to the secondary batteries so as to transmit the voltages outside the unit are short-circuited, the secondary batteries may be damaged, or the lead wires themselves may generate heat and be damaged. For example, charge voltage is about 4.2 V in the case where a lithium-ion battery is used as the secondary battery, so that assuming that the voltage of the secondary battery be 5 V, the internal resistance value thereof be 10 mΩ, and the resistance value of a wiring portion such as the lead wires be 5 mΩ, current I flowing when the lead wires are short-circuited is as large as 250 A (as a result of simple calculation of 5 V/(10 mΩ+5 mΩ+5 mΩ)).

An object of the present invention is therefore to provide a multiple series/multiple parallel battery pack which is capable of performing protective operation at a proper timing even when a large number of secondary batteries are connected, and which, even if lead wires for voltage measurement extending from secondary batteries are short-circuited, gives no damage to the secondary batteries or lead wires.

### Means for Solving the Problems

To attain the above object, according to the present invention, there is provided a multiple series/multiple parallel battery pack, including: a plurality of units which are connected in series or in parallel; and a control circuit for performing charging/discharging control by means of a control output signal output from each of the units, wherein each of the units is provided with a plurality of secondary batteries which are connected in series or in parallel, a function of detecting the voltages of the individual secondary batteries, a function of outputting the control output signal according to the result of the detection of the voltage, and lead wires for transmitting the voltages of the individual secondary batteries to the control circuit or an external circuit.

Each of the units need not have a switch element for opening or closing a power supply line connected to each secondary battery.

Preferably, a resistor is inserted in series into each of the lead wires, or a differential amplifier is connected to each of the lead wires so as to transmit the output thereof to the control circuit or an external circuit.

As described above, in the present invention, each of the units has a function of detecting the voltages of the individual secondary batteries, i.e., a detection circuit or the like, a circuit for determining necessity of stop of charging/discharging operation according to the result of the detection of the voltage, and a function of outputting a control output signal based on the determination result. Based on this control output signal, the control circuit provided outside the units controls a switch element such as an FET to thereby achieve protective operation. Further, lead wires are provided so as to allow the control circuit and a user side circuit provided outside the secondary battery pack to measure the voltages of the secondary batteries, so that it is possible to build a system capable of performing management of battery residual capacity or battery degradation determination using the control circuit or an external circuit. Further, a high resistor is inserted into each of the lead wires so as to prevent large current from flowing even if the lead wires are short-circuited, or a differential amplifier is connected to each of the lead wires so as to transmit the output thereof to the control circuit or an external circuit.

### Advantages of the Invention

According to the present invention, it is only necessary for the control circuit to control a switch element such as an FET based on the control output signal output from each unit, thus simplifying the control processing concerning protective operation. In order for the management of the battery residual capacity independent of the protective operation to be performed using the lead wires for voltage measurement extending from each of the secondary batteries, there arises no problem even if the time required for measuring the voltages of all the secondary batteries is longer than the time required for comparing the protective operation, so that there does not arise any serious problem even if a large number of secondary batteries are connected in series and/or in parallel.

Thus, according to the present invention, there can be provided a multiple series/multiple parallel battery pack which is capable of performing protective operation at a proper timing even when a large number of secondary batteries are connected, and which, even if lead wires for voltage measurement extending from secondary batteries are short-circuited, gives no damage to the secondary batteries or lead wires.

### BRIEF DESCRIPTION OF THE DRAWINGS

FIG. 1 is a circuit diagram illustrating a configuration of a battery pack according to an embodiment of a multiple series/multiple parallel battery pack according to the present invention.

FIG. 2 is a circuit diagram illustrating an example of a configuration of a unit used in the present embodiment.

FIG. 3 is a circuit diagram illustrating a configuration of a lead wire according to the present invention, in which FIG. 3(a) is a circuit diagram in the case where a resistor is inserted into a mid portion of the lead wire, and FIG. 3(b) is a circuit diagram in the case where a differential amplifier is connected to the mid portion of the lead wire.

FIG. 4 is a circuit diagram illustrating an example of a configuration of a conventional secondary battery pack.

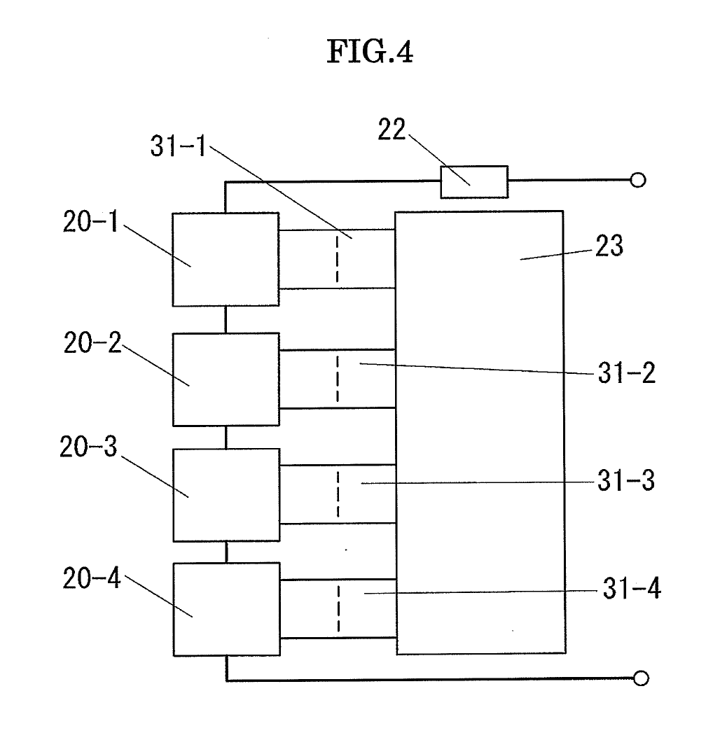

FIG. 5 is a circuit diagram illustrating an example of a configuration of one unit of the conventional secondary battery pack.

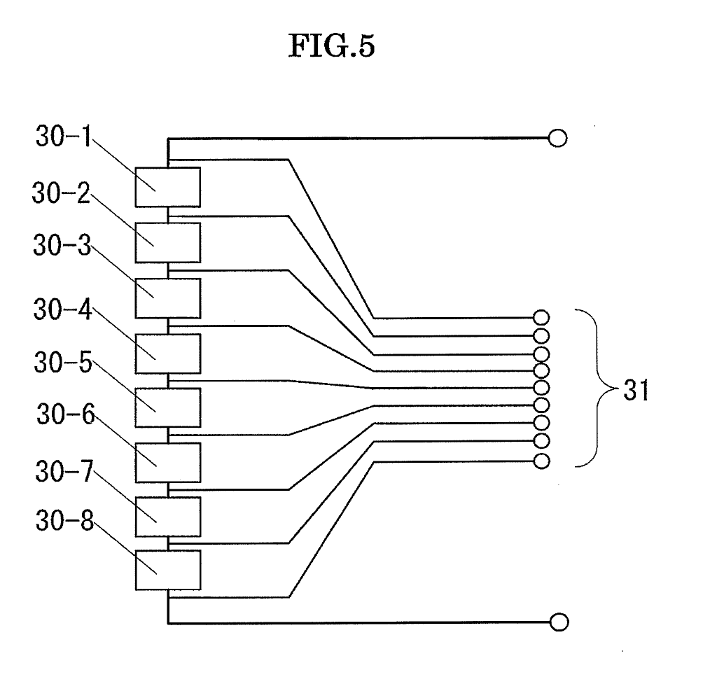

### BEST MODE FOR CARRYING OUT THE INVENTION

An embodiment of the present invention will be described below with reference to the accompanying drawings.

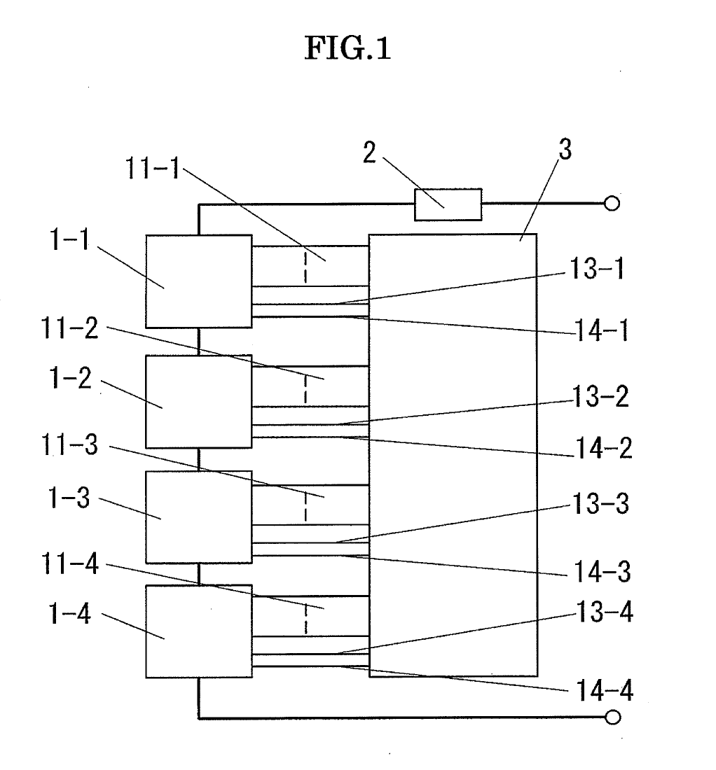

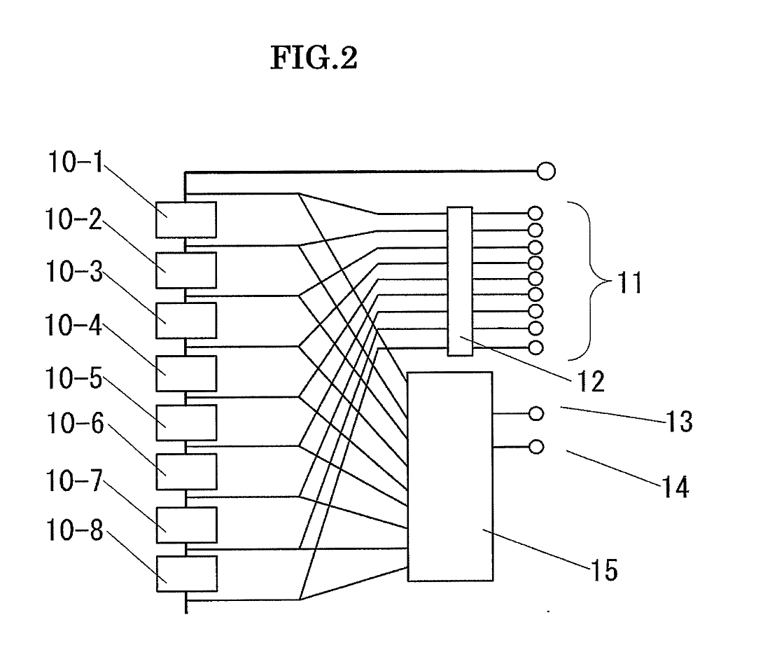

FIG. 1 is a circuit diagram illustrating a configuration of a battery pack according to an embodiment of a multiple series/multiple parallel battery pack, and FIG. 2 is a circuit diagram illustrating an example of a configuration of a unit used in the present embodiment. In FIG. 1, the battery pack according to the present invention has four units 1-1, 1-2, 1-3, and 1-4 which are connected in series and a control circuit 3 for performing charging or discharging control based on charging stop signals and discharging stop signals which are control output signals from respective units. In FIG. 2, each unit has eight secondary batteries 10-1 to 10-8 which are connected in series, a voltage detection circuit 15 having functions of detecting the voltage of each secondary battery and outputting a charging stop signal 13 or a discharging stop signal 14 based on a result of the voltage detection, and lead wires 11 for transmitting the voltages of individual secondary batteries to the control circuit 3 or an external circuit.

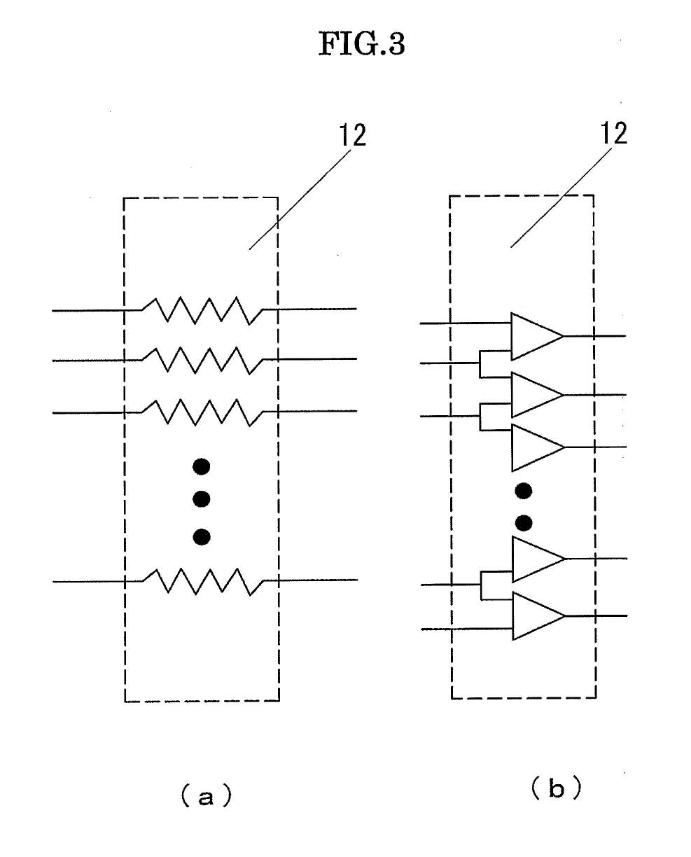

A resistor is inserted in series into a mid portion 12 of the lead wire extending from each unit, or a differential amplifier is connected thereto so as to transmit the output to the control circuit 3 or external circuit. FIG. 3 is a circuit diagram illustrating a configuration of the lead wire according to the present invention. FIG. 3(a) is a circuit diagram illustrating a configuration in the case where a resistor is inserted into the mid portion 12 of the lead wire, and FIG. 3(b) is a circuit diagram illustrating a configuration in the case where a differential amplifier is connected to the mid portion 12 of the lead wire.

As illustrated in FIG. 3(b), the differential amplifier, which is an operational amplifier, etc., is provided in one-to-one correspondence with each secondary battery. Voltages at both ends of each of the secondary batteries 10-1 to 10-8 are input to input terminals of the differential amplifier, and a differential voltage therebetween is output from an output terminal of the differential amplifier. The use of the differential amplifier allows the voltages at both ends of each of the secondary batteries 10-1 to 10-8 to be converted into voltage based on the ground level of the operational amplifier for output, so that it is possible to directly input voltage to be measured in the control circuit 3 to an A/D conversion circuit, thereby simplifying the circuit configuration of the control circuit 3.

In the case where a resister is inserted into the lead wire 11 as illustrated in FIG. 3 (a), the resistance value of the resistor to be inserted into the lead wire 11 is set to about 250 to 1 kΩ. Thus, even if adjacent lead wires 11 are short-circuited under the condition that the secondary batteries 10-1 to 10-8 are each a 5 V lithium-ion battery, current flowing in each of the short-circuited lead wires passes two resistors since one resistor is inserted into each lead wire, so that the current value is as low as 2.5 to 10 mA. Further, in the case of the unit illustrated in FIG. 2 where eight barriers are connected in series, the difference between the lead wires 11 for voltage measurement is up to 40 V (=5V×8 series-connected batteries). However, even if the relevant lead wires 11 are short-circuited, current of only 20 mA to 80 mA flows in each of the short-circuited lead wires. As a result, the secondary batteries 10-1 to 10-8 are not damaged, and heat generation and damage of the lead wires 11 does not occur.

Further, in the case of FIG. 3 (b) where not a resistor but a differential amplifier is connected to the mid portion 12 of the lead wire for voltage measurement, the energy of the secondary battery is not directly output, so that even if a short circuit occurs at a portion on the other side of the differential amplifier, the secondary batteries 10-1 to 10-8 are not damaged, and heat generation and damage of the lead wires 11 does not occur.

Although eight secondary batteries 10-1 to 10-8 are connected in series in the unit of FIG. 2, the number of the series-connected secondary batteries, presence/absence of parallel connection, and the number of parallel connections may be determined arbitrarily according to the purpose. The voltage detection circuit 15 may be constituted by a detection IC that detects over charge or over discharge of a lithium-ion battery or may be constituted by a circuit having a function of allowing a microcomputer or the like to measure the voltage using an A/D converter so as to detect overcharge or over discharge and a program of a microcomputer or the like.

In the battery pack according to the present embodiment, as illustrated in FIG. 1, the control circuit 3 is used to control the switch element 2 so as to perform protective operation concerning charging/discharging. The units 1-1 to 1-4 are connected to the control circuit 3 via the lead wires 11-1 to 11-4 for measuring the voltages of respective secondary batteries, charging stop signal lines 13-1 to 13-4, and discharging stop signal lines 14-1 to 14-4, and the control circuit 3 performs OR processing for the charging stop signals and discharging stop signals output from the respective units to thereby control the switch element 2. Further, measuring the voltages of the respective secondary batteries via the lead wires allows the state of each battery pack to be managed in detail, allows overcharge to be detected based on the measured current, and allows capacity to be calculated based on the measured voltage and current of each secondary battery.

In a conventional battery pack, the voltage of the secondary battery is processed by a microcomputer or the like on the control circuit using an A/D converter. In this configuration, when the number of units is increased, the time required to grasp all the voltages of the secondary batteries is accordingly increased. On the other hand, in the present embodiment, the determination on the protective operation can be made by the charging stop signals and discharging stop signals output from the units 1-1 to 1-4, thereby reducing the processing time. Further, the voltage of each secondary battery detected via the lead wire can be used for management of the residual battery capacity or battery state notification to a system main body connected to each battery pack.

Although four units are connected in series in the battery pack according to the present embodiment, the number of the series-connected units, presence/absence of parallel connection, and the number of parallel connections may be determined arbitrarily according to the purpose.

It goes without saying that the present invention is not limited to the above embodiment, but may be designed according to user's requirements and purposes. For example, the connection configuration (serial and/or parallel) of the secondary batteries or units and the number of the secondary batteries or units connected in series and/or in parallel are arbitrarily determined. Further, another protective circuit function or various types of battery information to be managed may be provided.

### INDUSTRIAL APPLICABILITY

In recent years, the use of the secondary battery such as a lithium-ion battery has extended into the field of a power supply for an electrically-powered device. Such a secondary battery is generally configured as a secondary battery pack formed integrally with a protection circuit that detects the voltage or current of the secondary battery and opens/closes a power supply line so as to perform charging/discharging control. In recent years, development of a high voltage/large capacity secondary battery pack has been demanded, and in order to comply with such a demand, a large number of secondary batteries are combined in series and in parallel so as to achieve a high voltage/large capacity power supply.

When the number of the secondary batteries used in the secondary battery pack is increased, a situation occurs in which the control circuit for performing the protective operation needs to monitor the voltages of all the large number of secondary batteries, thus taking much time for control processing of the control circuit, which may prevent detection of overcharge or overdischarge and prevent corresponding protective processing to be carried out at a proper timing. Further, in the case where the lead wires which are directly connected to the secondary batteries so as to transmit the voltages outside the unit are short-circuited, the secondary batteries may be damaged, or the lead wires themselves may generate heat and be damaged.

According to the present invention, there can be provided a multiple series/multiple parallel battery pack which is capable of performing protective operation at a proper timing even when a large number of secondary batteries are connected, and which, even if lead wires for voltage measurement extending from secondary batteries are short-circuited, gives no damage to the secondary batteries or lead wires, thus significantly enhancing industrial applicability.

### EXPLANATION OF REFERENCE SYMBOLS

1-1 to 1-4, 20-1 to 20-4: Unit
2, 22: Switch element
3, 23: Control circuit
10-1 to 10-8, 20-1 to 20-8: Secondary battery
11, 11-1 to 11-4, 31, 31-1 to 31-4: Lead wire
12: Mid portion of lead wire
13: Charging stop signal
13-1 to 13-4: Charging stop signal line
14: Discharging stop signal
14-1 to 14-4: Charging stop signal line
15: Voltage detection circuit

1. A multiple series/multiple parallel battery pack, comprising:
a plurality of units which are connected in series or in parallel; and
a control circuit for performing charging/discharging control by means of a control output signal output from each of the units, wherein
each of the units is provided with a plurality of secondary batteries which are connected in series or in parallel, a function of detecting the voltages of the individual secondary batteries, a function of outputting the control output signal according to the result of the detection of the voltage, and lead wires for transmitting the voltages of the individual secondary batteries to the control circuit or an external circuit.

2. The multiple series/multiple parallel battery pack according to claim 1, wherein
each of the units does not have a switch element for opening or closing a power supply line connected to each secondary battery.

3. The multiple series/multiple parallel battery pack according to claim 1, wherein
a resistor is inserted in series into each of the lead wires.

4. The multiple series/multiple parallel battery pack according to claim 1, wherein
a differential amplifier is connected to each of the lead wires so as to transmit the output thereof to the control circuit or an external circuit.
